(19) United States
(12) Patent Application Publication
(10) Pub. No.: US 2018/0332338 A1
(43) Pub. Date: Nov. 15, 2018

(54) METHOD AND APPARATUS FOR SATELLITE PATH PROTECTION FOR IP VIDEO NETWORKS

(71) Applicant: Kevin M. HARDEE, Plano, TX (US)

(72) Inventor: Kevin M. HARDEE, Plano, TX (US)

(21) Appl. No.: 15/591,363

(22) Filed: May 10, 2017

(51) Int. Cl. H04N 21/438; H04N 21/442; H04N 21/61; H04N 21/643; H04N 21/6405

(52) U.S. Cl. CPC H04N 21/4383; H04N 21/44209; H04N 21/6405; H04N 21/6143; H04N 21/64322; H04N 21/6112

(57) ABSTRACT

Various embodiments relate to a method and a receiver for receiving content including a satellite path protection (“SPP”) monitor configured to monitor the content from a satellite signal; and detect signal faults in the satellite signal and a SPP client configured to switch from the satellite signal to a terrestrial path and receive the content from the terrestrial path.

### TECHNICAL FIELD

This disclosure relates generally to satellite path protection, and more specifically, but not exclusively, to using a satellite protection client in a satellite receiver to switch to an internet based over the top video protection path during periods of satellite signal disruption.

### BACKGROUND

The loss of a video signal in an IP video network to satellite video end users caused by “rain fade” or other satellite distribution system issues, is a common source of satellite video end users frustration in using the service. During periods of severe weather, the loss of signal can affect public safety by preventing access to weather reports and Emergency System Alerts and can affect broadcasting of content to the end user.

Currently, for satellite systems, there are no known solutions for solving disruption system issues to satellite video end users. The only known alternative for end users is to manually switch to using a different device (e.g. PC/laptop/mobile device) or technology (off air antenna, if available) or to switch to a different service provider that utilizes a non-satellite distribution technology during the disruption.

During this disruption, the loss of signal prevents the content from being provided to the end user and further portions of content may not be recorded due the loss of the input signal because of the disruption.

Satellite providers are losing revenue subscribers due to the loss of input signal caused by the disruption.

### SUMMARY OF EXEMPLARY EMBODIMENTS

A brief summary of various embodiments is presented below. Embodiments address the need to integrate and develop a software based satellite protection client to be built into the satellite receiver which will enable the receiver to switch to an internet based “over the top” (“OTT”) video protection path during periods of satellite signal disruption.

In order to overcome these and other shortcomings of the prior art and in light of the present need to integrate and develop a software based satellite protection client to switch to an internet based “over the top” (“OTT”) video protection path during periods of satellite signal disruption, a brief summary of various exemplary embodiments is presented. Some simplifications and omissions may be made in the following summary, which is intended to highlight and introduce some aspects of the various exemplary embodiments, but not to limit the scope of the invention.

Detailed descriptions of a preferred exemplary embodiment adequate to allow those of ordinary skill in the art to make and use the inventive concepts will follow in later sections.

Various embodiments described herein relate to a receiver for receiving content, including a satellite path protection (“SPP”) monitor configured to monitor the content from a satellite signal and detect signal faults in the satellite signal; and a SPP client configured to switch from the satellite signal to a terrestrial path and receive the content from the terrestrial path.

In an embodiment of the present disclosure, the receiver further including the SPP monitor being further configured to detect whether the signal faults have ended and the SPP client being further configured to switch back to the satellite signal.

In an embodiment of the present disclosure, the receiver further including the SPP client being further configured to buffer the content from the terrestrial path to align the content with the content from the satellite signal and buffer the content from the satellite path to align the content with the content from the terrestrial path.

In an embodiment of the present disclosure, detecting, by the SPP monitor, signal faults in the satellite signal includes signal degradation, signal loss and data corruption.

In an embodiment of the present disclosure, the SPP monitor uses one of hysteresis and wait-to-restore timing to prevent path flapping between the satellite signal and the terrestrial path.

In an embodiment of the present disclosure, receiving, by the SPP client, the content from the terrestrial path is received through one of multicast internet protocol television stream tuning and over-the-top adaptive bit rate protocol reception.

In an embodiment of the present disclosure, the SPP client uses one of time markers, frame markers and adaptive bit rate manifests to align the content from the terrestrial path with the content from the satellite signal.

Various embodiments described herein relate to a method for switching between a satellite signal and a terrestrial path includes monitoring the content from a satellite signal, detecting signal faults in the satellite signal, switching from the satellite signal to a terrestrial path and receiving the content from the terrestrial path.

In an embodiment of the present disclosure, the method further includes detecting whether the signal faults have ended and switching back to the satellite signal.

In an embodiment of the present disclosure, the method further includes buffering the content from the terrestrial path to align the content with the content from the satellite signal and buffer the content from the satellite path to align the content with the content from the terrestrial path.

In an embodiment of the present disclosure, signal faults in the satellite signal includes signal degradation, signal loss and data corruption.

In an embodiment of the present disclosure, one of hysteresis and wait-to-restore timing are used to prevent path flapping between the satellite signal and the terrestrial path.

In an embodiment of the present disclosure, wherein the content from the terrestrial path is received through one of multicast internet protocol television stream tuning and over-the-top adaptive bit rate protocol reception.

In an embodiment of the present disclosure, one of time markers, frame markers and adaptive bit rate manifests are used to align the content from the terrestrial path with the content from the satellite signal.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

These and other more detailed and specific features are more fully disclosed in the following specification, reference being had to the accompanying drawings, in which:

FIG. 1 illustrates satellite path protection network architecture;

FIG. 2 illustrates another satellite path protection network architecture;

FIG. 3 illustrates a block diagram of home device architecture;

FIG. 4 illustrates a state machine diagram; and

FIG. 5 illustrates a flow chart for switching between a satellite signal and a terrestrial signal.

### DETAILED DESCRIPTION OF THE INVENTION

It should be understood that the figures are merely schematic and are not drawn to scale. It should also be understood that the same reference numerals are used throughout the figures to indicate the same or similar parts.

The descriptions and drawings illustrate the principles of various example embodiments. It will thus be appreciated that those skilled in the art will be able to devise various arrangements that, although not explicitly described or shown herein, embody the principles of the invention and are included within its scope. Furthermore, all examples recited herein are principally intended expressly to be for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments. Descriptors such as “first,” “second,” “third,” etc., are not meant to limit the order of elements discussed, are used to distinguish one element from the next, and are generally interchangeable.

A method and apparatus is needed to integrate and develop a software based satellite protection client to be built into the satellite receiver which will enable the receiver to switch to an internet based “over the top” (“OTT”) video protection path during periods of satellite signal disruption.

This method and apparatus is configured to allow the end user to have continued reception of linear video feeds and in the case where the receiver is also a Digital Video Recorder (“DVR”), the method and apparatus is further configured to be capable of continuing to record content through the alternate path.

Linear video channels are distributed through satellites which are also ingested into an OTT origin server and made available by a Content Delivery Network (“CDN”) as is typical for distribution of OTT video.

Satellite providers may already have such a network as part of a multiscreen offering, however, a component of the described method and apparatus is the Satellite Path Protection (“SPP”) Client. The SPP client may contain data mapping linear satellite channels to live OTT Universal Resource Locators (“URLs”) which are configured to be used for satellite path protection.

When the receiver detects loss of video on the satellite path, instead of displaying a loss of signal indicator to the screen of the end user, the SPP client would begin to source the video signal from the OTT video source URL. By using Wait to Revert (“WTR”) timing or other mechanism, path flapping between the satellite and OTT signals can be prevented.

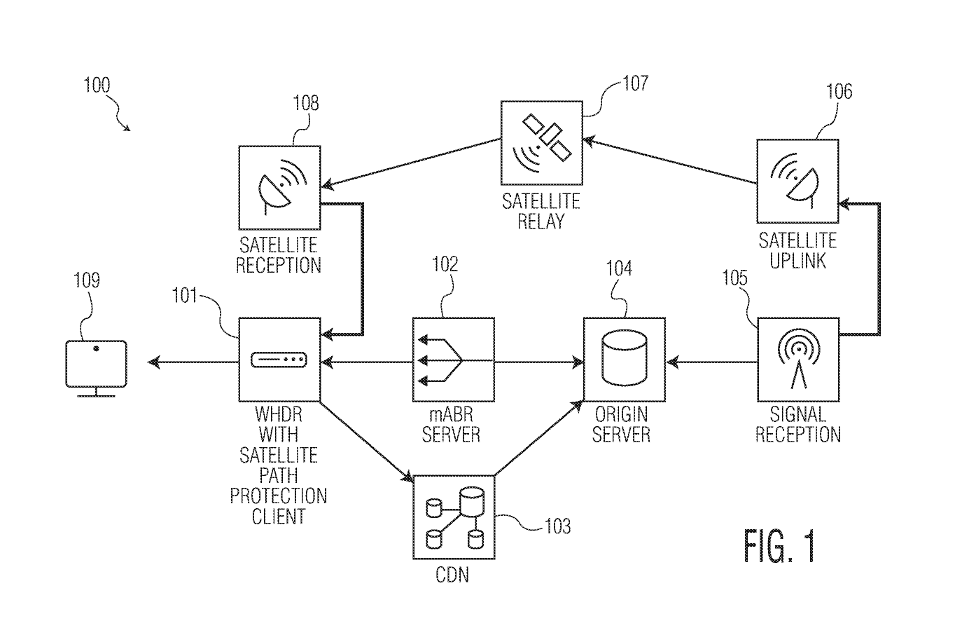

FIG. 1 illustrates an embodiment of a satellite path protection network architecture 100. The directional arrows in FIG. 1 represent push and pull operations. The SPP client 101 may include a DVR including a whole home DVR (“WHDVR”) and a multicast adaptive bitrate client (“mABR”). The SPP client 101 displays the signal on the display 109.

The SPP client is configured to provide protection of live satellite broadcasts and provide the protection path via mABR or unicast OTT.

The satellite path protection network architecture 100 may also include an origin server 104, a content delivery network (“CDN”) 103, a mABR server 102, and satellite architecture including a signal reception system 105, a satellite uplink 106, a satellite relay 107, and a satellite reception system 108.

FIG. 1 illustrates an embodiment of utilizing existing satellite protocols where the satellite provider provides both the content and the satellite provider is also the internet service provider (“ISP”). By providing both services, the providers may deliver content over an operator managed network which allows for bandwidth savings by using the mABR server 102.

In another alternative embodiment, when the provider is not providing both services, the CDN 103 may be used in place of the mABR server 102.

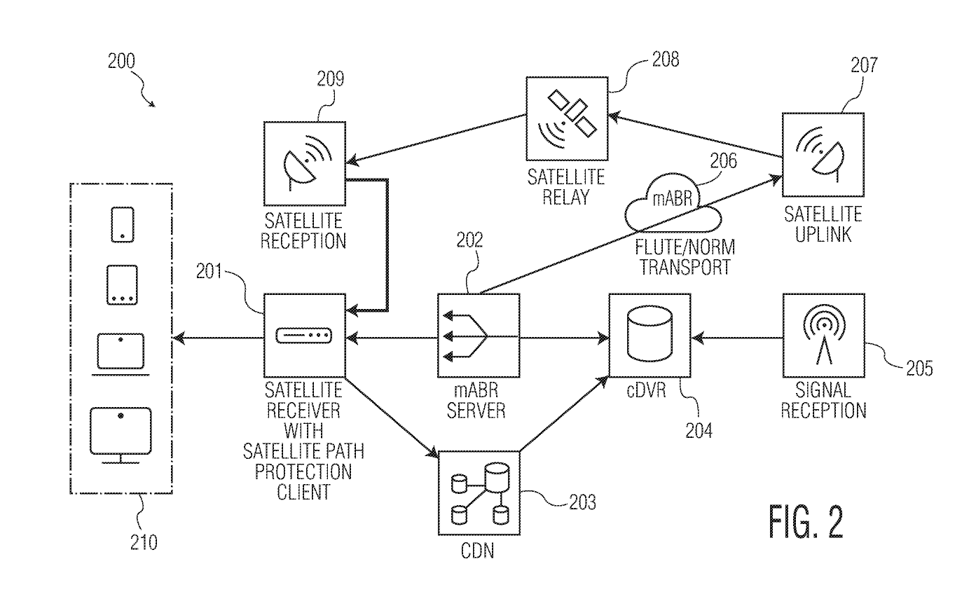

FIG. 2 illustrates another satellite path protection network architecture 200. The SPP client may be included in the SPP client 201. The SPP client 201 may also include a mABR client.

The satellite path protection network architecture 200 may also include a cDVR 204, a CDN 203, a mABR server 202, and satellite architecture including a signal reception system 205, a satellite uplink 207, a satellite relay 208, and a satellite reception system 209.

In another embodiment, when the provider is providing both services, the mABR may use multicast User Datagram Protocols (“UDP”), for example, File Delivery over Unidirectional Transport (“FLUTE”) or NORM transport protocols. Using ABR based satellite delivery allows for protection of recordings.

In this another embodiment, a Cloud DVR (“cDVR”) 204 may be used in place of the origin server 104. When a main screen attached to a satellite receiver is used (bottom device in 210), the main screen utilizes the SPP client 201 to protect the satellite path, however, when multi-screen devices 210 are used the multi-screen devices 210 receive content from the CDN 203. .

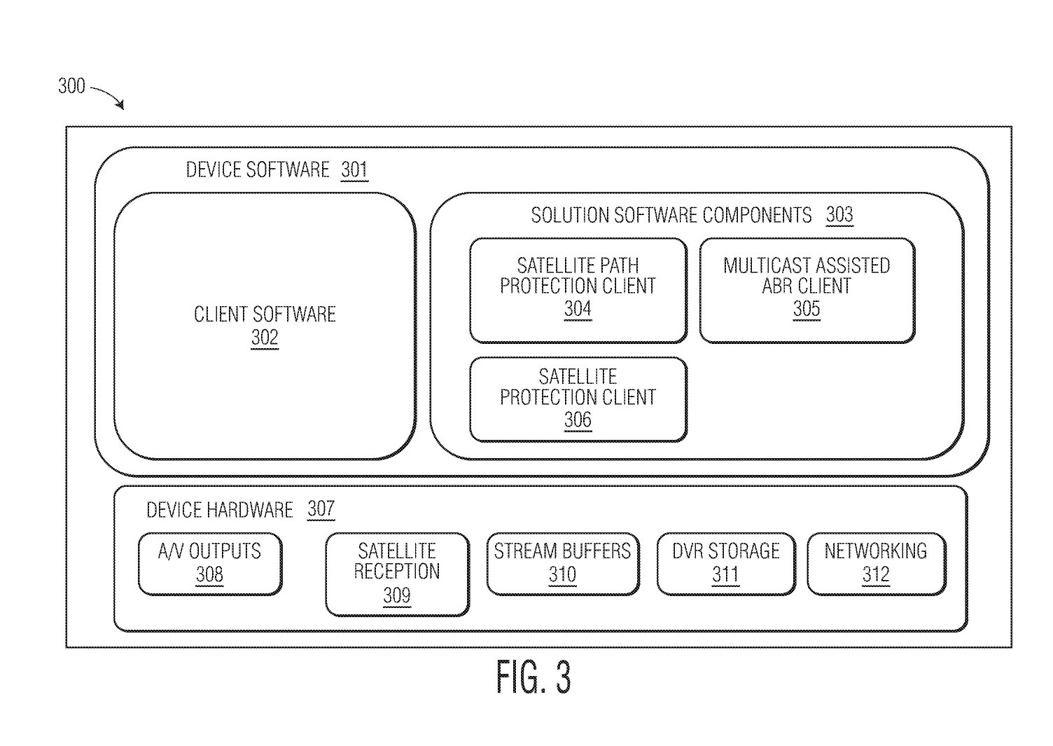

FIG. 3 illustrates an example of a home device architecture 300. The home device architecture may include device software 301 which may include client software 302 and protection software components 303 which may include a satellite path protection client 304, a multicast assisted ABR client 305, and a satellite protection monitor 306. The home device architecture may further include device hardware which may include A/V outputs 308, satellite reception 309, stream buffers 310, DVR storage 311, and networking 312.

Various alternative embodiments may not include all components in the home device architecture 300.

In another embodiment, the home device architecture 300 may not include the DVR storage 311.

In another embodiment, the home device architecture 300 may not include the multicast assisted ABR client 305.

In another embodiment, the home device architecture 300 may not include the DVR storage 311 and not include the multicast assisted ABR client 305.

The client software 302 which is included in the device software 301 includes software that is configured to control the reception and display of satellite video to customers of the satellite operator. In the case where the receiver is also a DVR, the client software 302 is configured to allow for the recording and playback of programming received via a satellite.

The satellite protection monitor 306 includes software which is configured to monitor incoming satellite signals for signal degradation and signal loss. The satellite protection monitor 306 is also configured to monitor the received video streams for data corruption. Up on detection of signal or stream faults, the satellite protection monitor 306 signals the client software 302 to switch to a backup terrestrial path. Upon detection of restoration of input video integrity, the satellite protection monitor 306 signals the client software 302 to revert to the primary satellite video path. The satellite protection monitor 306 uses hysteresis and/or waits to restore timing to prevent path rapid switching if the satellite signal is rapidly fading.

The satellite path protection client 304 includes software which is configured to allow for the reception of video from a backup terrestrial or OTA video path through traditional multicast IPTV stream tuning, by OTT adaptive bit rate protocol reception, or through other means.

The satellite path protection client 304 provides APIs to allow for optional pre-switch buffering of content from the backup path, whether the backup path be satellite path or terrestrial path. Time markers, frame markers, and/or ABR manifests are used to allow the satellite path protection client 304 to align content for display and recording. In the case where content is not aligned due to variations in delay of satellite and backup path and buffer sizing, path protection switching may optionally via configuration lose content to reduce real time delay in displaying content or delay displaying and recording of content while the input buffer aligns to the last displayed or recorded point.

The multicast assisted ABR client 305 is configured to allow for the reception of ABR protocols via multicast using protocols such as FLUTE and NORM.

The A/V output 308 may be any analog or digital output hardware used to provide audio and video to the end user.

The satellite reception 309 may be any hardware used to receive and decode the satellite signal. Typically this hardware includes signal strength detectors.

The stream buffers 310 may be any hardware device memory used to buffer video streams.

The DVR storage 311 may be any hardware device memory or HDD used for long term recording and playout of video content.

The networking 312 may be any hardware used to connect to a data communications network, operator network, or the Internet.

The satellite path protection client 304 may be configured to instantiate buffering and playout of as many channels as required to provide support for Linear TV, Picture in Picture, and multiple tuner DVRs.

The satellite path protection client 304 may utilize application programming interfaces (“APIs”) to buffer these channels.

An example of an API to buffer channels is a channel start interface, which includes a Channel ID and buffer size and which may be configured to notify the satellite path protection client 304 to tune to the terrestrial linear channel designated by Channel ID to begin buffering content from the terrestrial network for linear TV playout or DVR recording. Type indicates either stream type buffering for ABR protocol type buffering. Buffer size indicates total rolling buffer sizing to be maintained.

Another example of an API to buffer channels is a channel stop interface, which includes a Channel ID and buffer size and which may be configured to notify the satellite path protection client 304 to stop buffering content for the linear channel designated by Channel ID. Type indicates either stream type buffering for ABR protocol type buffering. Buffer size indicates total rolling buffer sizing to be maintained.

The satellite path protection client 304 may be configured to push stream channels to a buffer provided by the client software 302.

An example of an API to begin push stream channels is a start stream channel, which includes a channel ID, type, last time or frame ID and pointer to stream output buffer.

In the case where the linear interface is a traditional IPTV multicast video stream, the start stream channel interface will multicast join to the content received via multicast group associated with Channel ID and begin to output the video stream into the stream output buffer frame by frame aligning to the last time or frame ID, where possible.

In the case where the linear interface is an ABR video stream, this start stream channel interface will pull the video data from the terrestrial network or previously allocated circular buffer and push the data to the stream output buffer.

In the case where no input channel buffer has been instantiated by the start streaming channel interface prior to a call to start streaming channel, one will be instantiated as part of the start streaming channel interface call.

Another example of an API to stop push streaming of a channel is the stop streaming channel interface which includes a channel ID.

In the case where the linear interface is a traditional IPTV multicast video stream. The stop stream channel interface will leave the multicast group associated with channel ID and stop streaming output into the stream output buffer.

In the case where the linear channel is an ABR video stream, the satellite path protection client 304 will stop pulling video from the terrestrial network

If an input channel buffer was been instantiated by the start streaming channel interface call, the buffer will be freed.

For streaming ABR protocols which utilize a data pull design pattern, the satellite path protection client 304 may be mode configured to act as an ABR caster, ABR proxy, or an ABR cache.

Regardless of the mode configured, the satellite patent protection client 304 provides interfaces needed to return the necessary URLs associated with a given channel ID and to support pulling the appropriate manifest and video fragments as defined by the specified ABR protocol (e.g. MSS, HLS, DASH, etc.)

In ABR caster mode, the satellite path protection client 304 only provides the needed URLs for the client software 302 to pull content directly from the network.

In ABR proxy mode, the satellite path protection client 304 will either proxy requests to the network in the case buffering has not been started or will return content from local cache buffer storage in the case buffering has been started.

In ABR cache mode, the satellite path protection client 304 will deliver content from the local cache when available and fall back to the network when not available. In the case where buffering has been started, content will be available in the local cache.

The satellite path protection monitor 306 may be instantiated as many times as needed to monitor as many channels as required to provide support for Linear TV, Picture in Picture, and multiple tuner DVRs.

The satellite path protection monitor 306 may utilize APIs to monitor these channels.

An example of an API to monitor these channels is the start monitor interface which is configured to be used on a channel tune or DVR recording start to begin monitoring a satellite path. The caller may be required to provide callback information to receive path switch and path revert events.

The start monitor interface will perform and check that the configuration details are valid, perform a hardware access test, and upon success, begin monitoring. The start monitor interface will return a success code or a failure code.

The start monitor interface will then send path switch and revert events based on an internally defined state event model.

A call to start a monitor where one already exists will start monitoring with the new configuration, which is used for channel tuning.

Another example of an API to monitor these channels is the stop monitor interface which is configured to be used when a satellite path tuner is no longer in use due to either the user watching a DVR recording, when the DVR recording stops, the user begins a VOD playout, or other similar activities.

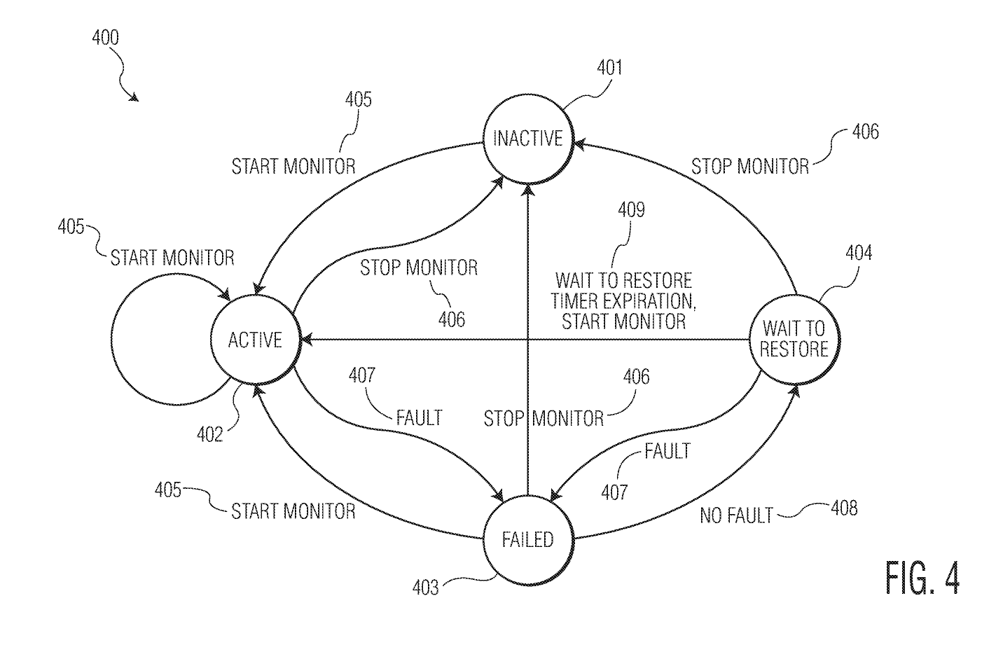

FIG. 4 illustrates the state machine diagram 400 for the satellite path protection monitor 306. The state machine diagram 400 includes an inactive state 401, an active state 402, a failed state 403, and a wait to restore state 404.

The inactive state 401 of the state machine diagram 400 may call a case start monitoring event 405. The case start monitoring event 405 calls the start monitor API providing monitor ID, Satellite Reception details, detection interval, wait to restore timing configuration, and callback information. The case start monitoring event 405 begins monitoring by looking for a satellite failure starting with configuration parameters including HW access test, transitions to active state 402, and the call returns a success code if HW access test succeeds, otherwise the call returns a failure code.

The active state 402 of the state machine diagram 400 may also call a case start monitoring event 405, which stops the current monitoring then follows the steps described above for the call start monitoring event 405.

The active state 402 may also call a case stop monitoring event 406. The case stop monitoring event 406 stops the monitoring, transitions to an inactive state 401, and the call returns a success code.

The active state 402 may also call a case fault event 407. The case fault event 407 detects HW failure, signal loss, signal degradation, or video stream error. The case fault event 407 begins looking for restoration of failure, transitions to a failed state 403, and notifies via call back to switch to a protection path with fault information.

The failed state 403 may call a case start monitoring event 405, as described above. The failed state 403 may also call a case stop monitoring event 406, as described above. The failed state 403 may also call a case no fault event 408. The case no fault event 408 detects restoration of failure. The case no fault event 408 begins looking for failure, transitions to wait to restore state 404 and the wait to restore timer is started.

The wait to restore state 404 may call a case start monitoring event 405, as described above. The wait to restore state 404 may also call a case stop monitoring event 406, as discussed above. The wait to restore state 404 may also call a case fault event 407, as described above. The wait to restore state 404 may also call a case wait to restore timer expiration 409. The case wait to restore timer expiration 409 begins looking for failures, transitions to an active state 402, and notifies via call back to revert back to satellite path.

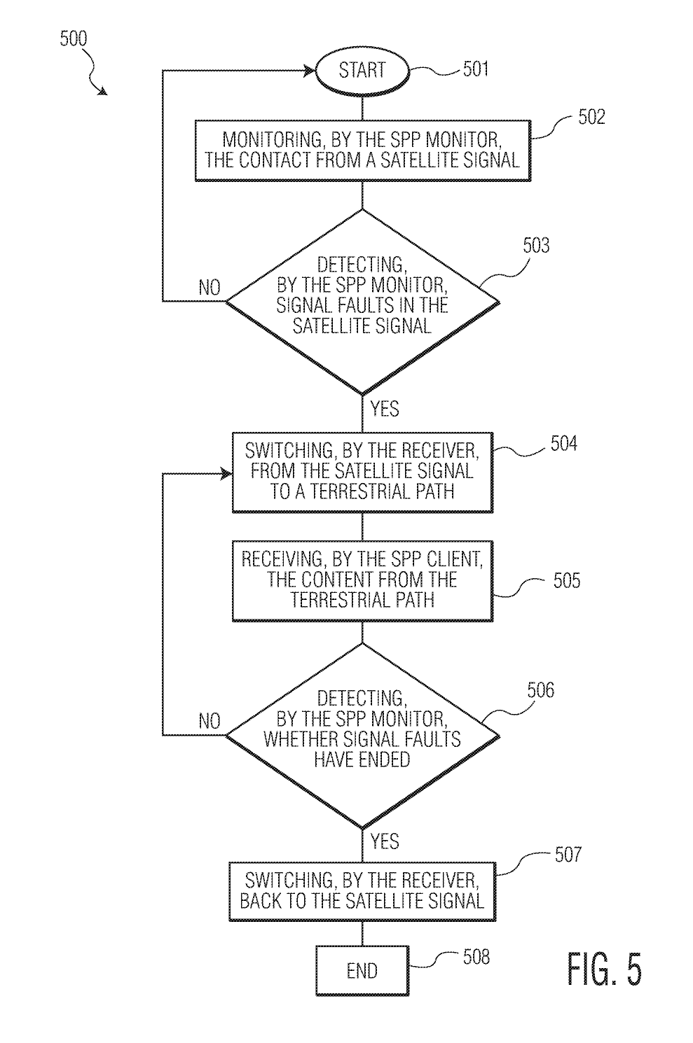

FIG. 5 illustrates a flow diagram for a method 500 for enabling the receiver to switch to an internet based OTT video protection path during periods of satellite signal disruption.

The method 500 begins at step 501. The method 500 then proceeds to step 502 where the SPP monitors the content from a satellite signal.

The method 500 then proceeds to step 503 where the SPP monitor detects signal faults in the satellite signal. If yes, signal faults are detected in the satellite signal, then the method 500 proceeds to step 504. If no, the method 500 returns to step 501.

At step 504, the receiver switches from the satellite signal to a terrestrial path.

The method 500 then proceeds to step 505 where the SPP client receives the content from the terrestrial path.

The method 500 then proceeds to step 506 where the SPP monitor detects whether the signal faults have ended. If yes, the method 500 proceeds to step 507 where the receiver switches back to the satellite signal. The method 500 then proceeds to step 508 to end. If the signal faults have not ended, the method 500 proceeds to step 505.

It should be apparent from the foregoing description that various exemplary embodiments of the invention may be implemented in hardware. Furthermore, various exemplary embodiments may be implemented as instructions stored on a non-transitory machine-readable storage medium, such as a volatile or non-volatile memory, which may be read and executed by at least one processor to perform the operations described in detail herein. A non-transitory machine-readable storage medium may include any mechanism for storing information in a form readable by a machine, such as a personal or laptop computer, a server, or other computing device. Thus, a non-transitory machine-readable storage medium may include read-only memory (ROM), random-access memory (RAM), magnetic disk storage media, optical storage media, flash-memory devices, and similar storage media and excludes transitory signals.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Accordingly, it is to be understood that the above description is intended to be illustrative and not restrictive. Many embodiments and applications other than the examples provided would be apparent upon reading the above description. The scope should be determined, not with reference to the above description or Abstract below, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A receiver for receiving content, comprising:
a satellite path protection (“SPP”) monitor, the SPP monitor comprising:
a memory; and
a processor configured to:
monitor the content from a satellite signal,
detect signal faults in the satellite signal; and
detect whether the signal faults have ended,
a client software module configured to receive a signal from the SPP monitor to switch from the satellite signal to a terrestrial path when signal faults are detected in the satellite signal; and
a SPP client, the SPP client comprising:
a memory; and
a processor configured to:
receive the content from the terrestrial path, and
switch back to the satellite signal.

2. (canceled)

3. The receiver of claim 1, further comprising:
the processor of the SPP client being further configured to:
buffer the content from the terrestrial path to align the content with the content from the satellite signal, and
buffer the content from the satellite path to align the content with the content from the terrestrial path.

4. The receiver of claim 1, wherein detecting, by the SPP monitor, signal faults in the satellite signal includes one of signal degradation, signal loss, and data corruption.

5. The receiver of claim 1, wherein the SPP monitor uses one of hysteresis and wait-to-restore timing to prevent path flapping between the satellite signal and the terrestrial path during a wait-to-restore time period.

6. The receiver of claim 1, wherein receiving, by the SPP client, the content from the terrestrial path is received through one of multicast internet protocol television stream tuning and over-the-top adaptive bit rate protocol reception.

7. The receiver of claim 3, wherein the SPP client uses one of time markers, frame markers, and adaptive bit rate manifests to align the content from the terrestrial path with the content from the satellite signal.

8. A method for switching between a satellite signal and a terrestrial path, comprising:
monitoring the content from a satellite signal,
detecting signal faults in the satellite signal,
detecting whether the signal faults have ended,
receiving a signal to switch from the satellite signal to a terrestrial path when signal faults are detected in the satellite signal; and
receiving the content from the terrestrial path, and
switching back to the satellite signal.

9. (canceled)

10. The method of claim 8, further comprising:
buffering the content from the terrestrial path to align the content with the content from the satellite signal, and
buffering the content from the satellite path to align the content with the content from the terrestrial path.

11. The method of claim 8, wherein signal faults in the satellite signal includes one of signal degradation, signal loss and data corruption.

12. The method of claim 8, wherein one of hysteresis and wait-to-restore timing are used to prevent path flapping between the satellite signal and the terrestrial path during a wait-to-restore time period.

13. The method of claim 8, wherein the content from the terrestrial path is received through one of multicast internet protocol television stream tuning and over-the-top adaptive bit rate protocol reception.

14. The receiver of claim 10, wherein one of time markers, frame markers and adaptive bit rate manifests are used to align the content from the terrestrial path with the content from the satellite signal.
